(19) United States
(12) Patent Application Publication
(10) Pub. No.: US 2003/0026924 A1
(43) Pub. Date: Feb. 6, 2003

(54) Embossed pottery bowl

(76) Inventors: Kenneth A. Fait, Missiion Viejo, CA (US); Robert W. Fait, Laguna Beach, CA (US)

Correspondence Address: Averill & Varn, 8244 Painter Ave., Whittier, CA, 90602, US

(21) Appl. No.: 09/921,249

(22) Filed: Aug. 3, 2001

(51) Int. Cl. B29C 59/02

(52) U.S. Cl. 428/34.1; 264/293; 425/392; 425/394

(57) ABSTRACT

An embossed pottery bowl, and an apparatus and method for embossing a design on a pottery bowl. A press block and die block are each secured to output ends of a pair of actuator arms and positioned on opposite sides of a sidewall of the pottery bowl with a recessed die cavity of the die block facing in the direction of the press block. The press and die blocks are urged toward each other, preferably by a pneumatically controlled arm, so as to plastically displace a portion of the sidewall into the recessed die cavity. The plastic displacement producing an embossed portion of the sidewall having a recessed surface and an opposite bas-relieved surface, with at least one the recessed and bas-relieved surface molded into the shape of the design.

### BACKGROUND OF THE INVENTION

The field of the invention pertains to pottery and pottery surface illustration and design. The invention relates more particularly to an embossing tool and method for embossing a design on a pliable raw clay sidewall of a pottery bowl, wherein a press block and a die block are urged toward each other from opposite sides of the raw clay sidewall so as to plastically displace a portion of the sidewall into a recessed die cavity of the die block in a shape of the design. The invention further relates to pottery bowls having designs embossed in such a manner.

It is appreciated that three-dimensional surface designs, such as bas-relief and recessed impressions, are commonly used in pottery to enhance aesthetic appeal. Bas-relief designs in particular are typically formed on pottery surfaces by affixing a separately molded clay design piece to a raw clay pottery bowl, and the clay design piece and the pottery bowl are subsequently dried together. Alternatively, it is known for both bas-relief and recessed designs to be integrally formed on the pottery surfaces during “slip-casting” of the pottery bowl itself. In the slip-casting process used to produce pottery bowls, a suspension of ceramic powder, usually in water, is poured into a mold made of plaster of paris. Water is absorbed by the mold, and a hard lining on the mold wall is built up to form the pottery bowl. However, surface designs integrally formed in this manner have been known to lack sufficient detail, providing only general outlines of the design. Additionally embossing processes which attempt to emboss a design on a slip-cast raw clay pottery bowl, have been known to collapse or compromise the pottery bowl structure.

### BRIEF SUMMARY OF THE INVENTION

It is an object of the present invention to provide an embossed pottery bowl having an embossed portion integrally formed on a sidewall by plastic displacement of a portion of the sidewall into the shape of the design.

It is a further object of the present invention to provide a simple and efficient apparatus for embossing a design on a raw clay sidewall of a pottery bowl which utilizes a press block positioned on one side of the sidewall to plastically displace a portion of the sidewall into a recessed die cavity of a die block positioned on the other side of the sidewall, to produce an embossed portion having a shape of the design.

It is a still further object of the present invention to provide a simple and efficient method for embossing a design on a raw clay sidewall of a pottery bowl by plastically displacing a portion of the raw clay sidewall into a recessed die cavity having a shape of the design.

The present invention is for an apparatus for embossing a design on a raw clay sidewall of a pottery bowl. The apparatus comprises a press block, and a die block having a recessed die cavity in a shape of the design. One of the press and die blocks is positioned adjacent an inner surface of the raw clay sidewall, and the other one of the press and die blocks is positioned adjacent an outer surface of the raw clay sidewall opposite the block adjacent the inner surface. When thus positioned, the recessed die cavity of the die block faces in a direction of the press block. The apparatus also has means for retractably urging the press and die blocks relatively toward each other so as to press the press block against the raw clay sidewall and plastically displace a portion of the raw clay sidewall into the recessed die cavity of the die block. In this manner an embossed portion of the raw clay sidewall which is produced which is molded in a shape of the design.

Additionally, the present invention is for a method for embossing a design on a raw clay sidewall of a pottery bowl. The method comprises the following steps. First a press block and a die block are provided, with the die block having a recessed die cavity in a shape of the design. Next, a first one of the press and die blocks is positioned alongside an inner surface of the raw clay sidewall. Next, a second one of the press and die blocks is positioned alongside an outer surface of the raw clay sidewall opposite the first one of the press and die blocks, with the recessed die cavity of the die block facing in a direction of the press block. Next, the press and die blocks are urged relatively toward each other so as to press the press block against the raw clay sidewall and plastically displace a portion of the raw clay sidewall into the recessed die cavity of the die block. This produces an embossed portion of the raw clay sidewall which is molded in the shape of the design. And finally, the press and die blocks are retracted from the raw clay sidewall to release the now embossed portion.

And finally, the present invention is for an improved pottery bowl having a sidewall with opposing first and second sidewall surfaces. The improvement comprises a plastically-displaced embossed portion of the sidewall. The embossed portion has a raised surface region in bas-relief from the first sidewall surface, and an indented surface region opposite the raised surface region which is recessed from the second sidewall surface. At least one of the raised and indented surface regions have a shape of a pre-determined design which was impressed thereon when the raised and indented surface regions were simultaneously formed by plastic displacement caused by a displacement force exerted against the second sidewall surface toward the first sidewall surface when previously in a pliable raw condition.

### BRIEF DESCRIPTION OF THE DRAWINGS

FIG. 1 is a partly cross-sectional side view of the embossing apparatus with press and die blocks straddled on opposite sides of a sidewall of a pottery bowl.

FIG. 2 is an enlarged cross-sectional side view of the press and die blocks operating to form an embossed portion plastically displaced toward the outer surface of the pottery bowl.

FIG. 2A is an enlarged view of the die block portion of FIG. 2 in an opened configuration.

FIG. 3 is a perspective view of a pottery bowl having plastically-displaced embossed portions produced thereon.

FIG. 4 is an enlarged cross-sectional side view of the press and die blocks similar to FIG. 3, shown operating to form an embossed portion plastically displaced toward the inner surface of the pottery bowl.

### DESCRIPTION OF THE PREFERRED EMBODIMENTS

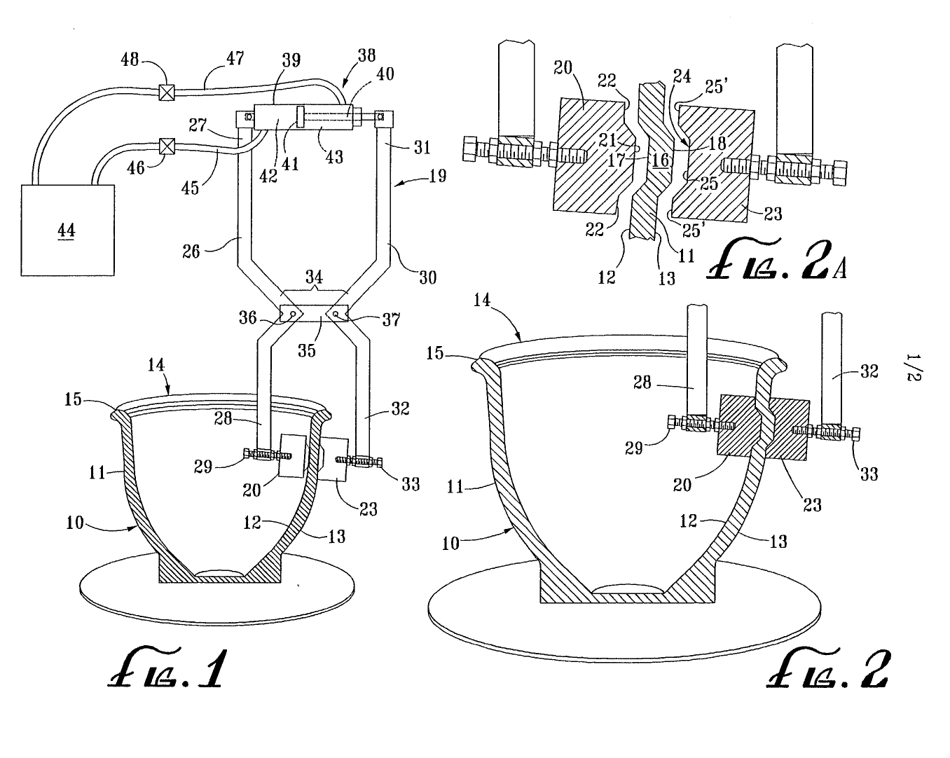

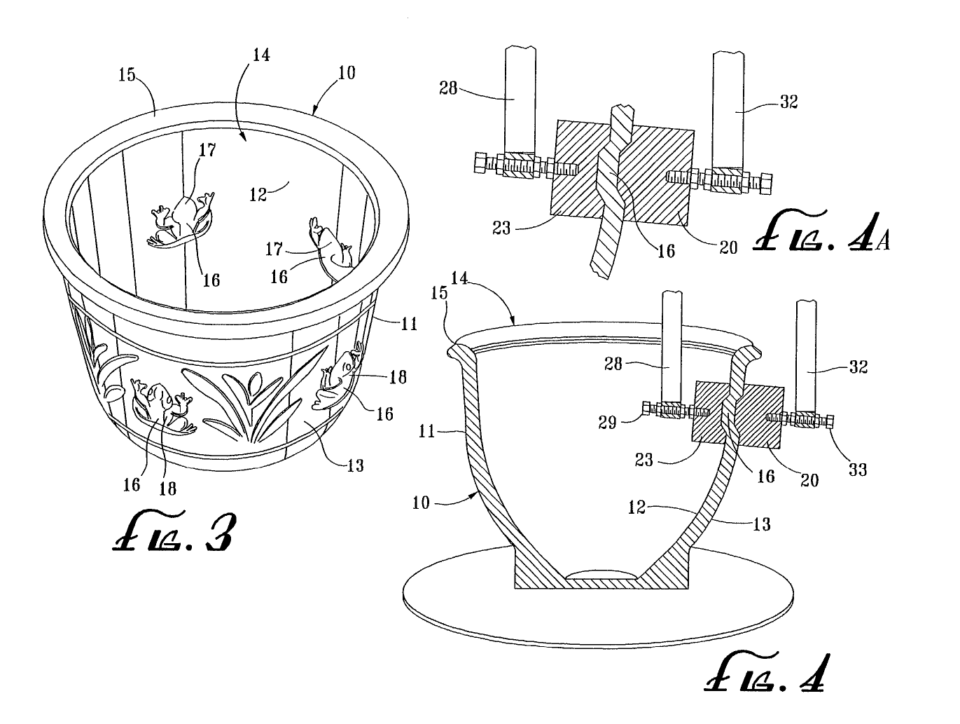

Referring now to the drawings, FIG. 1 shows a partly cross-sectional view of the embossing apparatus, generally indicated at reference character 19. The embossing apparatus 19 is shown straddled on opposite sides of a sidewall 11 of a pottery bowl, generally indicated at reference character 10. The sidewall 11 has inner and outer surfaces 12, 13 respectively, and extends to an upper rim 15 defining an open end 14. It is appreciated that the pottery bowl 10 shown in FIGS. 1, 2, and 4 is in a pliable raw state or condition prior to being subjected to a drying process which hardens and solidifies the pottery bowl 10. It is necessary for the pottery bowl 10 to be in such a pliable condition for proper operation of the embossing apparatus 19 and process of the present invention. FIG. 3, however, shows an example of a finalized pottery bowl 10 embodying a designated design, e.g. a frog, produced according to the present invention.

As can be best seen in FIG. 1, the embossing apparatus 19 preferably has a first actuator arm 26 hinged to a second actuator arm 30 at a hinge joint 34. It is appreciated that the term “hinge joint” is broadly defined as the dynamic joining of two or more bodies which enables relative pivoting motion therebetween. In this regard, the hinge joint 34 may be embodied either by a direct coupling of the bodies at a single common pivot axis, or an indirect coupling of two end bodies by means of at least one other linking body. Thus, as shown in FIG. 1, the hinge joint 34 utilizes a hinge linking arm 35 which is pivotally connected to the first actuator arm 26 at a first pivot axis 36 and which is independently pivotally connected to the second actuator arm 30 at a second pivot axis 37. In any event, the first 26 and second 30 actuator arms extend from the hinge joint 34 to output ends 28 and 32, respectively, which perform the embossing procedure on the pottery bowl as will be discussed in detail below. Preferably, the first 26 and second 30 actuator arms also extend from the hinge joint 34 in an opposite direction from the output ends 38, 32 to input ends 27 and 31, respectively. With the dual pivot axis arrangement of the hinge joint 34, it is appreciated that the distance between the input ends 27 and 31 is inversely proportional to the distance between the output ends 28 and 32. However, it is notable that the hinge joint 34 may alternatively employ the use of a single pivot axis in a scissor-like configuration, which produces a proportional relationship between the input ends spacing and the output ends spacing. In any case, it is appreciated that the resulting hinged configuration will produce an output force at the output ends 28, 32 which is proportional in magnitude to an input force exerted at the input ends 27, 31.

As can be further seen in FIG. 1, a pneumatic arm assembly is shown, generally indicated at reference character 38, which is operably connected to the input ends 27 and 31 of the pair of actuator arms 26, 30. The pneumatic arm assembly 38 typically has a generally piston-cylinder configuration, including a cylinder 39 and a piston 40 slidably seated within the cylinder 39. FIG. 1 illustrates a preferred configuration for operably connecting the pneumatic arm assembly 38 to the input ends 27, 31. As shown, one end of the cylinder 39 is pivotally connected to the first input end 27, and an oppositely protruding end of the piston 40 is pivotally connected to the second input end 31. In this manner, operation of the pneumatic arm assembly 38 will exert an equal and opposite input force on the input ends 27, 31. It is appreciated, however, that while the connection point of the pneumatic arm assembly 38 to the pair of actuator arms has been illustratively chosen to be the input ends 27, 31 it is not limited only to such. Generally, any input portion along the respective pair of actuator arms 26, 30 may be designated for exerting the input force thereon, so long as the input portion is suitably spaced from the output ends 28, 32 and the hinge joint 34 in order to produce leverage.

Furthermore, a pressure chamber (e.g. 42) is defined within the cylinder 39 which is in dynamic relation to the piston 40 such that an increase in air pressure in the pressure chamber (42) causes displacement of the piston 40. Such piston displacement operates to exert an equal and opposite input force on the input ends 27, 31 of the pair of actuator arms 26, 30, which in turn produces the equal and opposite output force at the output ends 28, 32. For producing the required piston displacement, an air compressor 44 is typically utilized, with air lines (e.g. 45) delivering compressed air to the pressure chamber (42). It is known to applicant that compression pressures of approximately 120 psi generated by the air compressor 44 have been sufficient to produce favorable embossing results. In a preferred embodiment, the pressure chamber is preferably divided into a first sub-chamber 42 and a second sub-chamber 43 which are on opposite sides of a piston head 41 of the piston 40. As shown, a first air line 45 supplies compressed air to the first sub-chamber 42, and a second air line 47 supplies compressed air to the second sub-chamber 43. Furthermore, a first air valve is provided on the first air line 45 which adjusts the pressure level of the compressed air entering the first sub-chamber 42, and a second air valve is provided on the second air line 47 which adjusts the pressure level of the compressed air entering the second sub-chamber 43. This configuration enables variation of the pressure levels between the first and second sub-chambers 42, 43 to produce a pressure differential on opposite sides of the piston head 41. Small pressure differentials will produce proportionately small piston displacements, while large pressure differentials will produce proportionately large piston displacements. In this manner, the level of the input force exerted on the pair of actuator arms 26, 30 may be adjusted, so as to adjust and control the degree of actuation at the output ends 28, 32 as well.

As can be seen in FIGS. 1, 2 and 2A, a press block 20 is secured to the output end 28 of the first actuator arm 26 by means of a mounting bolt 29. And a die block 23 is similarly secured to the output end 32 of the second actuator arm 30 by means of a mounting bolt 33. This configuration positions the press block 20 adjacent the inner surface 12 of the sidewall 11, and the die block 23 adjacent the outer surface 13 of the sidewall 11. Alternatively, FIGS. 4 and 4A illustrates the reverse situation where the press block 20 is secured to the second actuator arm 30 adjacent the outer surface 13, and the die block 23 is secured to the first actuator arm 26 adjacent the inner surface 12. The placement of the press and die blocks 20, 23 on the inner surface 12 or outer surface 13 of the sidewall will ultimately determine the direction of plastic displacement of a resulting embossed design 16 (FIGS. 2 and 4), as will be discussed in detail below. While the following discussion particularly examines the particular placement and configuration shown in FIG. 2, all considerations apply equally to the configuration in FIG. 4 as well.

As can be seen in FIG. 2A, the press block 20 preferably has a central active press surface 21, generally having a convex configuration, and a peripheral passive press surface 22 surrounding the active press surface 21. The active press surface 21 is raised above the passive press surface 22 and functions to contact and displace a portion of the sidewall 11 in the embossing process. In contrast, the passive press surface 22 is contoured to the inner surface 12 of the sidewall 11 to provide even support to the areas of the inner surface 12 surrounding the displaced portion of the sidewall 11 during the embossing process. This may help to prevent tears along the edges of the embossed design 16 and thereby protect the integrity of the pottery sidewall 11. And the die block 23 shown in FIG. 2 has a recessed die cavity 24 which is oriented to face in the direction of the press block 20. Preferably, the recessed die cavity 24 is surrounded by a peripheral die block support surface 25′ which is contoured to the outer surface 13 of the sidewall 11 for providing support thereto during the embossing process, in a manner similar to the passive press surface 21 of the press block 20.

In this manner, and upon exertion of an input force at the input ends 27, 31 of the pair of actuator arms 26, 30, the press and die blocks 20, 23 are urged relatively toward each other to sandwich the sidewall 11 therebetween. It is notable that relative movement of the press and die blocks 26, 30 toward each other includes the scenario where both the press and die blocks 26, 30 are advanced with respect to the sidewall 11. Additionally, it also includes the scenario where the die block is held against and in place with respect to the sidewall 11, and only the press block 20 is advanced toward the sidewall 11 and the die block 23. In any event, the sandwiching effect of the sidewall 11 between the press and die blocks 26, 30 results in plastic displacement of the contacted portion of the sidewall 11 into the recessed die cavity 24 of the die block 23. The displacement is considered “plastic” due to the substantially undisturbed integrity of the sidewall construction even after the embossing process. In this manner, the resulting molded formation, or the embossed portion 16, is produced having a raised or bas-relieved surface 18 which is substantially contoured to the cavity surface 25 of the recessed die cavity 24, and an indented or recessed surface 17 which is substantially contoured to the active press surface 21 of the press block 20. It is notable, however, that while this plastic displacement operates to fill the recessed die cavity 24, it is not necessarily limited to a complete filling thereof. It is also notable that the output/displacement force utilized to produce the plastic displacement is typically only sufficient to displace the embossed portion in the direction of the displacement force, without causing aberrant displacement in a direction normal to that force.

And finally, the resulting embossed portion 16 shown in FIGS. 2-4 has the designated design molded thereon. Because the recessed die cavity 24 of the die block 23 is preferably in the shape of the designated design, such as a frog or leaves as illustrated in FIG. 3, the bas-relieved surface 18 of the embossed portion 16 will typically have the design molded thereon. Thus, the die block 23 is preferably positioned along the outer surface 13 of the sidewall 11 such that the design on the bas-relieved surface 18 may be easily viewed. Alternatively, however, the active press surface 21 may also be formed in the shape of the design such that the recessed surface 17 of the embossed portion 16 may be molded into the design. In this case, the press block 20 is preferably positioned along the outer surface 13 of the sidewall 11 such that the design on the recessed surface 17 may be viewed. Alternatively still, both the recessed die cavity 24 of the die block 23 and the active press surface 21 of the press block 20 may be in the shape of the designated design. In this case, the active press surface 21 is shaped to substantially mate with the recessed die cavity 24 of the die block 23, so as to produce raised 18 and indented 17 surfaces impressed with the design and substantially contoured to each other. This last scenario is shown in FIG. 3, where the embossed portions 16 have both the raised/bas-relieved surface 18 and the recessed surface 17 in the shape of the frog.

It is notable that the pottery bowl 10 is of the type typically moldably-constructed from clay or other ceramic material which is pliably moldable when in an initially raw state, and hard and rigid after a drying process, typically by application of heat. It is appreciated that the term “raw clay sidewall” is used herein and in the claims to define a pliable and moldable condition which is typically characteristic of raw clay, but which is not limited only to clay material. Thus other types of ceramic materials may also be utilized which have a pliable, clay-like physical characteristics necessary for operation of the present invention.

It is also notable that the term “pottery bowl” utilized herein and in the claims is understood to include other pottery articles and structures, such as cups, jars, pans, pots, vases, vessels, art craft, etc., utilitarian or otherwise, and is not limited to bowls, bowl-shaped constructions, or other container-type constructions. Furthermore, it is not limited to structures having an open end or enclosed structures partially or completely surrounding a volume.

And finally the term “design” or “embossed design” is not limited only to aesthetic designs as illustrated in the figures. Rather, such embossed designs produced according to the present invention can also be functional, such as an handle produced by the embossing apparatus and method described herein.

The present embodiments of this invention are thus to be considered in all respects as illustrative and not restrictive; the scope of the invention being indicated by the appended claims rather than by the foregoing description. All changes which come within the meaning and range of equivalency of the claims are intended to be embraced therein.

I claim:

1. An apparatus for embossing a design on a raw clay sidewall of a pottery bowl, said apparatus comprising:
a press block;
a die block having a recessed die cavity in a shape of the design, a first one of the press and die blocks for positioning adjacent an inner surface of the raw clay sidewall, and a second one of the press and die blocks for positioning adjacent an outer surface of the raw clay sidewall opposite the first one of the press and die blocks with the recessed die cavity of the die block facing in a direction of the press block; and
means for retractably urging the press and die blocks relatively toward each other so as to press the press block against the raw clay sidewall and plastically displace a portion of the raw clay sidewall into the recessed die cavity of the die block to thereby produce an embossed portion of the raw clay sidewall which is molded in a shape of the design.

2. The apparatus as in claim 1,
wherein the press block has an active press surface shaped to substantially mate with the recessed die cavity of the die block for contactedly producing the embossed portion of the raw clay sidewall when pressed thereagainst.

3. The apparatus as in claim 2,
wherein the press block has a passive press surface which is peripheral to the active press surface and which is contoured to a corresponding one of the inner and outer surfaces of the raw clay sidewall for providing support thereto during formation of the embossed portion of the raw clay sidewall.

4. The apparatus as in claim 1,
wherein the press block has an active press surface for contactedly producing the embossed portion of the raw clay sidewall when pressed thereagainst, and a passive press surface which is peripheral to the active press surface and which is contoured to a corresponding one of the inner and outer surfaces of the raw clay sidewall for providing support thereto during formation of the embossed portion of the raw clay sidewall.

5. The apparatus as in claim 4,
wherein the active press surface is shaped to substantially mate with the recessed die cavity of the die block.

6. The apparatus as in claim 1,
wherein the die block has a die block support surface which is peripheral to the recessed die cavity and which is contoured to a corresponding one of the inner and outer surfaces of the raw clay sidewall for providing support thereto during formation of the embossed portion of the raw clay sidewall.

7. The apparatus as in claim 1,
wherein the means for retractably urging the press and die blocks relatively toward each other comprises:
a pair of actuator arms operably connected to each other at a hinge joint, with each actuator arm extending from the hinge joint to an output end which is connected to a corresponding one of the press and die blocks; and
means for pivoting the pair of actuator arms about the hinge joint and relatively toward each other.

8. The apparatus as in claim 7,
wherein the means for pivoting the pair of actuator arms comprises:
pneumatic means having a generally piston-cylinder configuration which encloses a pressure chamber and which operably connects to the pair of actuator arms at input portions thereof with the input portions spaced from the hinge joint and the output ends, for exerting an equal and opposite input force on the input portions due to displacement of the piston to an equilibrium position when compressed air is introduced into the pressure chamber;
a compressed air source; and
means for delivering compressed air from the compressed air source to the pressure chamber.

9. The apparatus as in claim 8,
wherein the pressure chamber comprises first and second sub-chambers which are divided by a piston head of the piston, and the means for delivering compressed air includes a first air line to the first sub-chamber and a second air line to the second sub-chamber, and
further comprising valve means for adjustably varying the pressure of the compressed air delivered to each of the first and second sub-chambers so as to produce a pressure differential on opposite sides of the piston head for controlling the degree of piston displacement and resulting input force.

10. A method for embossing a design on a raw clay sidewall of a pottery bowl, said method comprising the steps of:
providing a press block and a die block, with the die block having a recessed die cavity in a shape of the design;
positioning a first one of the press and die blocks alongside an inner surface of the raw clay sidewall;
positioning a second one of the press and die blocks alongside an outer surface of the raw clay sidewall opposite the first one of the press and die blocks, with the recessed die cavity of the die block facing in a direction of the press block;
urging the press and die blocks relatively toward each other so as to press the press block against the raw clay sidewall and plastically displace a portion of the raw clay sidewall into the recessed die cavity of the die block to thereby produce an embossed portion of the raw clay sidewall which is molded in the shape of the design; and
retracting the press and die blocks from the raw clay sidewall.

11. The method as in claim 10,
further comprising the step of providing a pair of actuator arms operably connected to each other at a hinge joint, with each actuator arm extending from the hinge joint to an output end which is connected to a corresponding one of the press and die blocks, and
wherein the step of urging the press and die blocks relatively toward each other includes pivoting the pair of actuator arms about the hinge joint and relatively toward each other.

12. The method as in claim 11,
wherein the step of pivoting the pair of actuator arms includes exerting an equal and opposite input force on the pair of actuator arms at input portions thereof which are spaced from the hinge joint and the output ends.

13. The method as in claim 12,
wherein the input force is pneumatically exerted by delivering compressed air to a pressure chamber of a piston-cylinder configuration operably connected to the input portions to thereby displace the piston to an equilibrium position.

14. In a pottery bowl having a sidewall with opposing first and second sidewall surfaces, the improvement comprising:
a plastically-displaced embossed portion of the sidewall having a raised surface region in bas-relief from the first sidewall surface, and an indented surface region opposite the raised surface region which is recessed from the second sidewall surface, at least one of the raised and indented surface regions having a shape of a pre-determined design impressed thereon when the raised and indented surface regions were simultaneously formed by plastic displacement caused by a displacement force exerted against the second sidewall surface toward the first sidewall surface while previously in a pliable raw condition.

15. The improved pottery bowl as in claim 14,
wherein each of the raised and indented surface regions have the shape of the pre-determined design impressed thereon and substantially contoured to each other.
